(19) United States
(12) Patent Application Publication
(10) Pub. No.: US 2009/0158033 A1
(43) Pub. Date: Jun. 18, 2009

(54) METHOD AND APPARATUS FOR PERFORMING SECURE COMMUNICATION USING ONE TIME PASSWORD

(76) Inventors: Younseo Jeong, Daejeon-city (KR); Boheung Chung, Daejeon-city (KR); Kiyoung Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/201,011

(22) Filed: Aug. 29, 2008

(30) Foreign Application Priority Data
Dec. 12, 2007 (KR) 10-2007-0128924

(51) Int. Cl. H04L 9/32

(52) U.S. Cl. 713/156

(57) ABSTRACT

The invention relates to a communication method and system using a one time password (OTP). The communication system includes: a user computer that has an OTP generator for generating the OTP provided therein; a service server that performs user authentication using user information and an OTP value input from the user computer, and communicates with the user computer using the encoded data that is associated with the OTP value, when the user authentication succeeds; and an OTP integrated authentication server that verifies the OTP value between the user computer and the service server.

### BACKGROUND OF THE INVENTION

1. Field of the Invention

The present invention relates to a communication method and system using an one time password, and more particularly, a communication method and system using one time password information that can perform encryption communication through user authentication using an one time password (OTP) between a user computer and a service server.

The invention was supported by the IT R&D program of MIC/IITA [2006-S-039-02, Embedded Secure Operating System Technology Development].

2. Description of the Related Art

In general, user IDs and passwords have been used for user authentication. The user authentication method using IDs and passwords has problems in that it is easy to find out IDs and passwords by analogy and it is not sufficient as an authentication means to provide protection against many malicious programs, such as keyboard hooking programs.

In recent years, generally, a TCP/IP protocol, which is an Internet protocol, has been used for communication over the Internet. The TCP/IP protocol is likely to be damaged by hacking, such as sniffing or IP spooling, since it has been designed without considering security. As such, the Internet environment has a problem in that packets transmitted during communication are likely to be disclosed to the outside (for example, interception or eavesdropping). However, most of the current communication systems over the Internet perform user authentication using an authentication method based on user IDs and passwords. Therefore, when the user IDs and passwords are disclosed, the communication systems are increasingly likely to be hacked.

In order to solve these problems, during electronic commerce or Internet banking, high-security authentication tools, such as security cards, have been used. In other communication services over the Internet, in order to ensure security, encryption communication, such as SSL (secure sockets layer) or IPSEC (IP security protocol), has been performed to protect transmission data.

The encryption communication includes a public key encryption method and a secret key encryption method. The two methods need to separately manage the keys in order to perform encryption communication, which requires a lot of time and efforts. In the secret key encryption method, the size of the key is smaller than that in the public key encryption method, but the secret key encryption method has a problem in the secure transmission and storage of the key. Actually, some communication networks are too complicated to manage the key. Systems using the secret key encryption method require a trusted third party for managing the keys. As the disclosure time of the keys to the outside increases, the keys are more likely to be decoded. Therefore, it is necessary to frequently change the keys.

Meanwhile, FIG. 1 is a diagram illustrating the structure of a communication system over the Internet according to the related art. A communication service procedure in the communication system according to the related art is performed as follows. The communication system according to the related art includes a user computer 1 that wants to use a service and a service server 2 that is connected to the user computer through the Internet, performs a user authentication process, and provides the service when the user authentication succeeds.

The user computer 1 provides a user ID and a password to the service server 2 through the Internet in order to receive various services from the service server 2. The service server 2 performs user authentication using user information (ID and password) received from the user computer 1. In this case, when the user authentication is completed and user login is checked, the service server 2 establishes a session for communication and provides various services to the user computer 1 through the established session.

For example, when a user uses the user computer 1 to access an Internet site for viewing moving pictures or listening to music (for example, a broadcasting site, a movie site, or a music site), the service server 2 of the Internet site performs user authentication using a user ID and a password, establishes a session for communication, and provides moving picture or music services to the user.

However, in the communication system having the above-mentioned configuration, since communication is performed over the Internet, user information included in the packets transmitted between the user computer 1 and the service server 2 is likely to be disclosed or copied. As a result, the user information is hacked.

Further, whenever the session established when the user computer 1 is connected to the service server 2 through the user authentication is updated, the user computer 1 should pass a new user authentication process.

### SUMMARY OF THE INVENTION

The invention is designed to solve the above problems of the related art, and an object of the invention is to provide a communication system and method that uses an OTP generator to simplify the structure of a key generation management portion required a lot of processing operations and management systems for encryption communication in the related art, thereby providing encryption communication using a small amount of data.

Another object of the invention is to provide a communication system and method that enforces the security of user authentication by performing user authentication using a one time password (OTP) to provide services in an Internet environment, and provides encryption communication using the enforced user authentication.

Still another object of the invention is to provide a communication system and method that skips a user authentication process when the same user is accessed through the user authentication process to receive services.

According to an aspect of the invention, a communication system includes: a user computer that has an OTP (one time password) generator for generating an OTP provided therein; a service server that performs user authentication using user information and an OTP value input from the user computer, and communicates with the user computer using encoded data that is associated with the OTP value, when the user authentication succeeds; and an OTP integrated authentication server that verifies the OTP value between the user computer and the service server.

The user computer may include: the OTP generator that generate a one time password (OTP); and a first encryption communication module that transmits user information and an OTP value generated by the OTP generator to the service server, and performs encryption communication with the service server using data encoded by the OTP value.

The service server may include a second encryption communication module that performs a user authentication process using the OTP value input from the user computer through communication with the OTP integrated authentication server, and when the user authentication succeeds, transmits or receives encoded data that is associated with the OTP value to or from the user computer.

The OTP integrated authentication server may include the same OTP generating function as that in the OTP generator of the user computer, use the OTP generating function to verity the OTP value when the service server requests to verify the OTP value, and provide a new OTP value using the OTP generating function when the service server requests to transmit the OTP value.

According to another aspect of the invention, there is provided a user computer for using a communication service. The user computer includes: an OTP generator that generate a one time password (OTP); and a first encryption communication module that transmits user information and an OTP value generated by the OTP generator to a service server which provides the communication service, in order to perform user authentication, and performs encryption communication with the service server using data encoded by the OTP value.

The first encryption communication module may include a first timer that measures the duration of a session established for the encryption communication, and the first encryption communication module may receive a new OTP value from the OTP generator at a predetermined time interval of the duration of the session that is measured by the first timer, and encode communication data.

The first encryption communication module may include a session monitoring unit that monitors whether the session established for the encryption communication is updated. Whenever the session monitoring unit determines that the session is updated, the first encryption communication module may receive a new OTP value from the OTP generator and encodes communication data.

The first encryption communication module may include a first encoding/decoding unit that encodes or decodes communication data using the OTP value as an encryption key, and the first encoding/decoding unit may convert the size and/or value of the OTP and uses the converted data as the encryption key.

According to still another aspect of the invention, there is provided a service server for providing a communication service. The service server includes: a second encryption communication module that performs a first user authentication process on the basis of user information input from a user computer that requests the communication service, verifies an OTP value input from the user computer through communication with an OTP integrated authentication server, thereby performing a second user authentication process, and when the user authentication of the user computer succeeds, performs encryption communication with the user computer using encoded data that is associated with the OTP value.

The second encryption communication module may include a session establishing unit that establishes a session for encryption communication with the user computer. Whenever the session establishing unit establishes the session in response to the communication service request of the user computer, the second encryption communication module may receive a new OTP value from the OTP integrated authentication server, and encode communication data.

The second encryption communication module may include a second timer that measures the duration of the session established by the session establishing unit. The second encryption communication module may receive a new OTP value from the OTP integrated authentication server at a predetermined time interval of the duration of the session that is measured by the second timer, and encode communication data.

The second encryption communication module may include a session establishing unit that establishes a session for encryption communication with the user computer. When initial user authentication of the user computer succeeds using user information and an OTP value that are input from the user computer and the session establishing unit establishes a new session in response to a communication service request of the user computer, the second encryption communication module may skip the user authentication process.

The second encryption communication module may include a second encoding/decoding unit that encodes or decodes communication data using the OTP value as an encryption key, and the second encoding/decoding unit may convert the size and/or value of the OTP and uses the converted data as the encryption key.

According to yet another aspect of the invention, there is provided a communication method using a one time password (OTP). The method includes: receiving user information and an OTP value from a user computer in a service server; performing a first user authentication process using the user information; querying an OTP integrated authentication server for the OTP value to verify the OTP value, thereby performing a second user authentication process; and when the first and second user authentication processes succeed, establishing a session for communication with the user computer, and performing encryption communication through the established session, using data encoded by the OTP value.

The performing of the encryption communication may include: measuring the duration of the session established for the encryption communication; and receiving a new OTP value from the OTP integrated authentication server at a predetermined time interval of the duration of the session, and encoding communication data.

The performing of the encryption communication may further include: determining whether the session established for the encryption communication is updated; and whenever it is determined that the session is updated, receiving a new OTP value from the OTP integrated authentication server and encoding the communication data.

The performing of the encryption communication may further include: whenever it is determined that the session is updated, determining whether the same user computer accesses.

According to still yet another aspect of the invention, there is provided a communication method using a one time password (OTP). The method includes: receiving an OTP value for user authentication from an OTP generator in a user computer; transmitting user information and the OTP value to a service server; and when the user authentication succeeds and the service server establishes a session for communication, performing encryption communication through the established session, using data encoded by the OTP value.

The performing of the encryption communication may include: measuring the duration of the session established for the encryption communication; and receiving a new OTP value from the OTP generator at a predetermined time interval of the duration of the session and encoding communication data.

The performing of the encryption communication may further include: determining whether the session established for the encryption communication is updated; and whenever it is determined that the session is updated, receiving a new OTP value from the OTP generator and encoding the communication data.

According to the above-mentioned aspects of the invention, an OTP generator is used to simplify the structure of a key generation management portion that is required a lot of processing operations and management systems for encryption communication in the related art. As a result, it is possible to provide encryption communication using a small amount of data.

According to the above-mentioned aspects of the invention, a communication system that performs user authentication using a one time password in an Internet environment and provides data communication is constructed. As a result, it is possible to prevent user authentication information and data from being hacked during the use of the Internet.

According to the above-mentioned aspects of the invention, encryption communication using a new one time password is performed at a predetermined time interval during communication over the Internet or whenever a session for communication is updated. As a result, it is possible to perform high-security communication.

According to the above-mentioned aspects of the invention, when the same user having passed user authentication accesses the system, the user authentication process skipped even though the session is updated. As a result, it is possible to provide convenient communication services.

### BRIEF DESCRIPTION OF THE DRAWINGS

FIG. 1 is a diagram illustrating the structure of a communication system over the Internet according to the invention;

FIG. 2 is a diagram illustrating the overall structure of an encryption communication system using an OTP according to an embodiment of the invention;

FIG. 3 is a block diagram illustrating the internal structure of the communication system shown in FIG. 2;

FIG. 4 is a block diagram illustrating the internal structure of a first encryption communication module shown in FIG. 3;

FIG. 5 is a block diagram illustrating the internal structure of a second encryption communication module shown in FIG. 2; and

FIGS. 6 and 7 are flowcharts illustrating a communication method according to another embodiment of the invention.

### DESCRIPTION OF THE PREFERRED EMBODIMENTS

Hereinafter, an exemplary embodiment of the invention will be described with reference to the accompanying drawings. In general, an electronic commerce system and an Internet banking system use high-security authentication means, such as a security card, a one time password (hereinafter, referred to as an OTP), and biometrics, and protect transmission data through encryption communication, such as SSEL or IPSEC. In this embodiment, user authentication, an encryption communication method, and a system therefor that improve the security of a general communication service through the Internet using an OTP generator which is limitedly used in Internet banking will be described. A description of structures common to the OTP will be omitted.

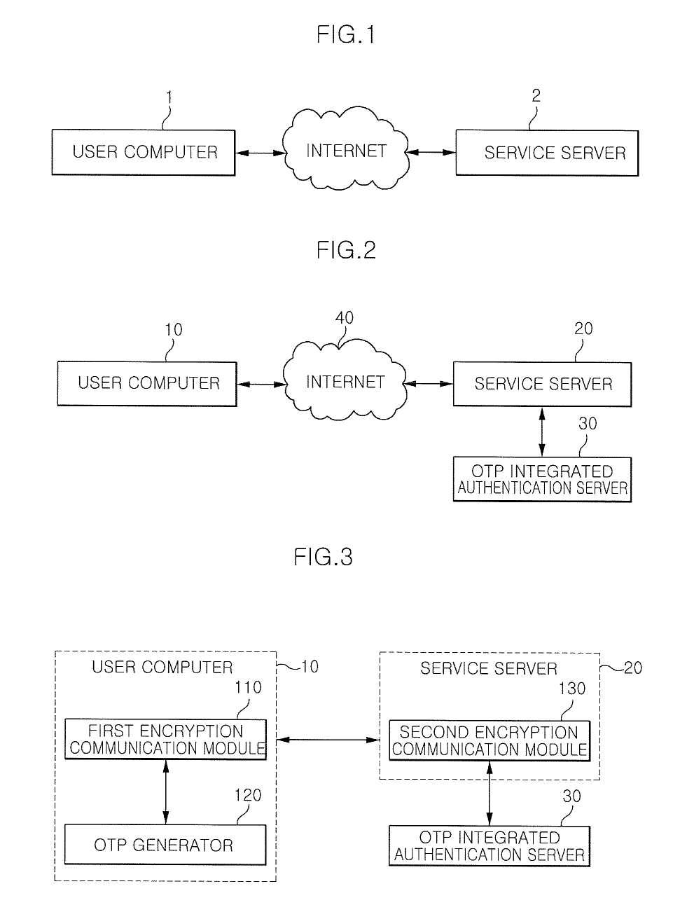

FIG. 2 is a diagram illustrating the overall structure of a communication system using an OTP according to this embodiment of the invention. As shown in FIG. 2, the communication system using an OTP according to this embodiment includes a user computer 10 that receives a service, a service server 20 that provides the service, and an OTP integrated authentication server 30 that provides a user authentication service using the OTP between the user computer 10 and the service server 20.

The user computer 10 is a computer that can access the Internet or a terminal that has a function corresponding thereto. The user computer 10 may include a device having an OTP generating function or OTP generating software installed therein, or it may be connected to an external device having an OTP generating function. The user computer 10 accesses the service server 20 to use a communication service through the Internet, and provides extracted user information or OTP value to the service server 20.

The service server 20 provides an Internet service to the user computer 10 through a user authentication process. The service server 20 performs a first user authentication process using user information (ID and password) of the user computer 10 that wants to access. The service server 20 identifies the OTP value received from the user computer 10 through a question and answer process with the OTP integrated authentication server 30, thereby performing a second user authentication process. That is, the service server 20 performs user authentication using the user information and OTP value of the user computer 10 that wants to access. Therefore, it is possible to further improve security.

When the user authentication of the user computer 10 succeeds, the service server 20 establishes a session for communication with the user computer 10, and the user computer 10 and the service server 20 perform encoded data communicate therebetween using the OTP value used in the user authentication process. In this way, encryption communication is performed therebetween. That is, the service server 20 performs encryption communication with the user computer 10 using the OTP value, which makes it possible to prevent illegal access from the outside.

In this way, the encryption communication system according to this embodiment can improve the security of Internet communication through the first and second user authentication processes between the user computer 10 and the service server 20.

The OTP integrated authentication server 30 identifies the OTP value in association with an OTP generated by the user computer 10. That is, the service server 20 may authenticate a user using a different password whenever performing a user authentication process for the user computer 10.

In the one time password (OTP) method, a new password is generated whenever the user wants to be authenticated. The OTP method can be applied to various detailed methods (for example, a question and answer method, a time synchronization method, an event synchronization method and a combination method).

For example, in the question and answer method, the user computer 10 inputs an OTP value received from the service server 20 to an algorithm, receives a response thereto, and transmits the response to the service server 20 for user authentication. In the time synchronization method, time is used as an OTP generation input value, and a password is changed at a predetermined time interval. In the event synchronization method, the service server 20 and the user computer 10 generate a password on the basis of the same count value, instead of time information. The combination method is used to make up for the disadvantages of the time synchronization method and the event synchronization method, and uses both a time value and a count value as the OTP generation input value. In the combination method, a new password is generated at a predetermined time interval, and when an OTP generation request is issued again in the same time period, the count value is increased to generate a new password.

The OTP integrated authentication server 30 may perform the user authentication process using the OTP even when communication is performed between a plurality of user computers 10 and a plurality of service servers 20 through the Internet. That is, when a plurality of service servers 20 request to identify OTP values, the OTP integrated authentication server 30 can individually identify the OTP values. When the service servers 20 request to provide new OTP values, the OTP integrated authentication server 30 can provide new OTP values for encryption communication, thereby integrally managing the identification and generation of OTP values.

The OTPs may be used in association with each other between the user computer 10 and the service server 20.

Therefore, the service server 20 does not need to include a separate unit for generating and identifying an OTP value.

Next, the internal structure of the communication system according to this embodiment will be described in detail with reference to the drawings.

FIG. 3 is a block diagram illustrating the internal structure of the communication system shown in FIG. 2.

As shown in FIG. 3, the user computer 10 includes a first encryption communication module 110 that performs encryption communication with the service server 20 and an OTP generator 120 that provides an OTP value to the first encryption communication module 110.

The OTP generator 120 may be connected to an external interface or it may be provided in the system in the form of software.

When the OTP generator 120 of the user computer 10 is provided outside the system, the OTP generator 120 may generate an OTP value in response to information input through its buttons. The OTP generator 120 may be provided in advance with an interface for connection to the user computer 10 (for example, a USB or a serial/parallel interface) or middleware capable of automatically extracting an OTP value during encryption communication between the user computer 10 and the service server 20.

The service server 20 includes a second encryption communication module 130 that identifies the OTP transmitted from the first encryption communication module 110 of the user computer 10 and encodes/decodes the OTP value.

The OTP integrated authentication server 30 identifies the OTP value queried by the second encryption communication module 130 of the service server 20, and it may generate and provide an OTP value when the second encryption communication module 130 requests to generate an OTP value.

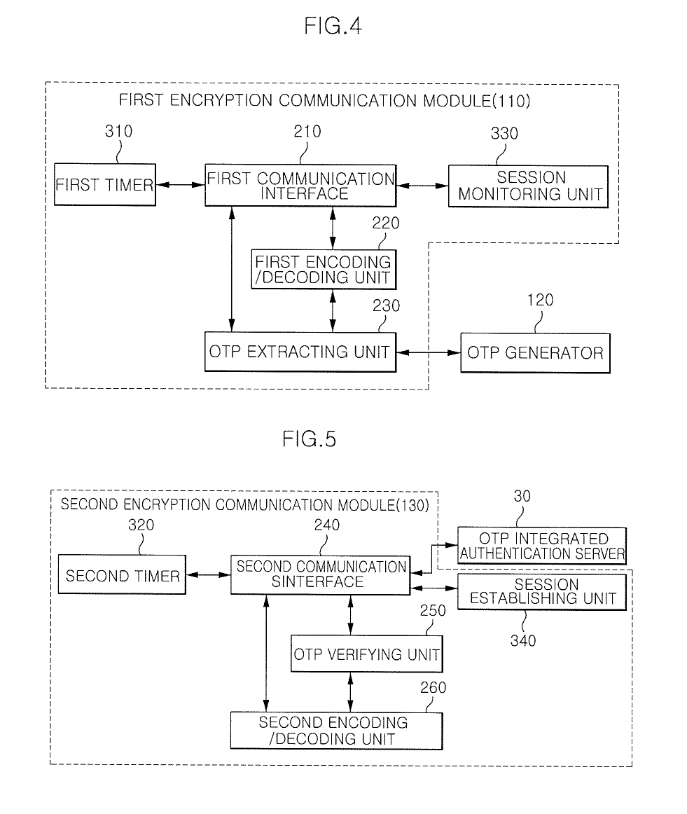

FIG. 4 is a block diagram illustrating the internal structure of the first encryption communication module shown in FIG. 3. As shown in FIG. 4, the first encryption communication module 110 includes a first communication interface 210 that controls encryption communication, a first encoding/decoding unit 220 that encodes or decodes data, an OTP extracting unit 230 that extracts the OTP value generated by the OTP generator 120, a first timer 310, and a session monitoring unit 330.

The first communication interface 210 extracts the OTP value generated by the OTP generator 120 using the OTP extracting unit 230 when accessing the service server 20. The first communication interface 210 transmits user information (for example, ID and password) and the OTP value to the service server 20 for user authentication. When the user authentication is normally performed, the first communication interface 210 establishes a session for encryption communication with the service server 20, and the first encoding/decoding unit 220 encodes or decodes data transmitted through the session.

An encryption key used for the encoding operation of the first encoding/decoding unit 220 may be changed to a new encryption key when a predetermined time has elapsed. That is, when the service server 20 completes the user authentication process, the first communication interface 210 establishes a session that is operatively associated with the service server 20, and encodes or decodes data transmitted from the first encoding/decoding unit 220 to start encryption communication. In this case, when the first timer 310 measures the duration of the session and provides the measured result, the first communication interface 210 uses the OTP extracting unit 230 to extract a new OTP value from the OTP generator 120 at a predetermined time interval, in order to allow the first encoding/decoding unit 220 to use the extracted OTP value for encoding or decoding.

If the communication session to the service server 20 ends and a new session is established, the first encoding/decoding unit 220 performs data transmission/reception using a new encryption key without the user authentication process. However, if not, the process ends. That is, when the service server 20 completes the user authentication process, the first communication interface 210 establishes a session that is operatively associated with the service server 20. At that time, the session monitoring unit 330 monitors the start, end, and update of the session, and notifies the first communication interface of the monitoring result. Whenever the session is updated, the first communication interface 210 uses the OTP extracting unit 230 to extract a new OTP value from the OTP generator 120, in order to allow the first encoding/decoding unit 220 to use the extracted OTP value for encoding.

The first encoding/decoding unit 220 uses the extracted OTP value as encryption key (ENCRYPT_KEY) for encryption communication between the user computer 10 and the service server 20. That is, the first communication interface 210 provides a variable OTP value and user authentication information to the service server 20, and the first encoding/decoding unit 220 uses the provided OTP value to perform encryption communication. Therefore, it is possible to improve the security of communication.

The OTP value (OTP_KEY) extracted by the first encoding/decoding unit 220 may be directly used as the encryption key (ENCRYPT_KEY). Alternatively, the encryption key size and value of the OTP may be changed by an encryption key conversion function (F( )). That is, the first encoding/decoding unit 220 encodes data for communication using a variable OTP value or an encryption key obtained by converting the OTP value. Therefore, it is possible to improve the security of data.

In this case, a function for converting the OTP value of the first encoding/decoding unit 220 into an encryption key can be appropriately selected, if necessary, as in the follow Examples:

### Example 1

### ENCRYPT_KEY=OTP_KEY, OTP_KEY:OTP value; and

### Example 2

### ENCRYPT_KEY=F(OTP_KEY), F( ):conversion function.

Example 1 indicates that an OTP value is used as an encryption key without any conversion, and Example 2 indicates that a key conversion function is used to generate a new key. In this case, the user computer 10 and the service server 20 should have the same key conversion function.

Therefore, the first encoding/decoding unit 220 encodes data transmitted/received to/from the service server 20 using an OTP value or an encryption key obtained by converting the OTP value using the key conversion function. Therefore, it is possible to prevent hacking and thus improve the security of communication.

In addition, the use of the OTP generator makes it possible to simplify the structure of a key generation management portion that requires a lot of processing operations and management systems during the encryption communication according to the related art.

FIG. 5 is a block diagram illustrating the internal structure of the second encryption communication module shown in FIG. 2. As shown in FIG. 5, the second encryption communication module 130 includes a second communication interface 240, an OTP verifying unit 250, a second encoding/decoding unit 260, a second timer 320, and a session establishing unit 340.

First, the second communication interface 240 identifies user information (for example, ID and password) transmitted from the user computer 110 using its own user authentication function, thereby performing a first user authentication process. The OTP verifying unit 250 identifies the OTP value received from the user computer 10 through a question and answer process with the OTP integrated authentication server 30, thereby performing a second user authentication process.

When the user authentication using the OTP value is completed, the second communication interface 240 establishes a session for encryption communication with the user computer 10 using the session establishing unit 340. Then, the second encoding/decoding unit 260 encodes or decodes the encoded data transmitted from the first encryption communication module 110 of the user computer 10 through the session.

Therefore, the second encryption communication module 130 performs the user authentication of the user computer 10 using the user information and the OTP value, and encodes or decodes received data or data to be transmitted using the OTP value. As a result, it is possible to further improve the security of communication.

When a predetermined time has elapsed, the second communication interface 240 of the second encryption communication module 130 may query the OTP integrated authentication server 30 for a new key value, receive an OTP value, and perform a user authentication process. That is, when the user authentication of the user computer 10 is completed, the second communication interface 240 establishes a session and starts encryption communication. The second timer 320 measures the duration of the session, and provides the measured result to the second communication interface 240. The second communication interface 240 receives a new OTP value from the OTP integrated authentication server 30 at a predetermined time interval of the duration of the session, in order to allow the second encoding/decoding unit 260 to use the received OTP for encoding.

When the communication session to the user computer 10 ends or is updated, the second communication interface 240 may examine whether the same user computer 10 transmits a request to establish a session. In this case, the second communication interface 240 can identify the same user on the basis of access information of the user computer (for example, user information, an OTP value, and an IP address of the user computer).

When there is a new session request from the user computer 10, the second communication interface 240 receives a new key value and performs encoding/decoding processes without the replication of user authentication. When there is no new session request, the process ends. That is, when the user authentication of the user computer 10 is completed, the second communication interface 240 establishes a session and starts encryption communication. The session establishing unit 320 starts, ends, or updates the session according to the request of the user computer. Whenever the session establishing unit 340 updates the session, the second communication interface 240 receives a new OTP from the OTP integrated authentication server 30, in order to allow the second encoding/decoding unit 260 to use the received OTP value for encoding.

Therefore, when the user authentication of the user computer 10 succeeds, the second encryption communication module 130 may skip the user authentication process when communicating with the same user computer 10. As a result, it is possible to improve the convenience of communication.

Next, a communication method using the above-mentioned communication system according to another embodiment of the invention will be described with reference to the drawings. In the following description, the same components as those shown in FIGS. 1 to 5 have the same functions as described above.

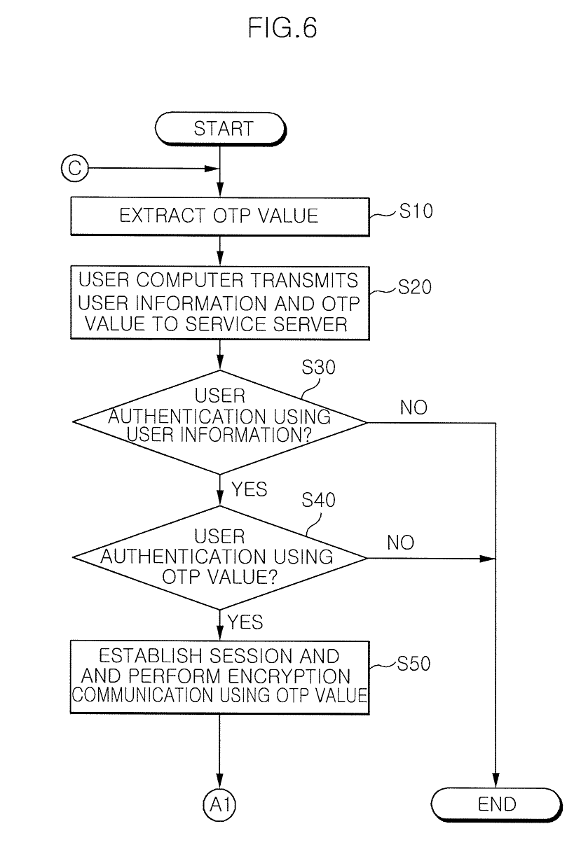

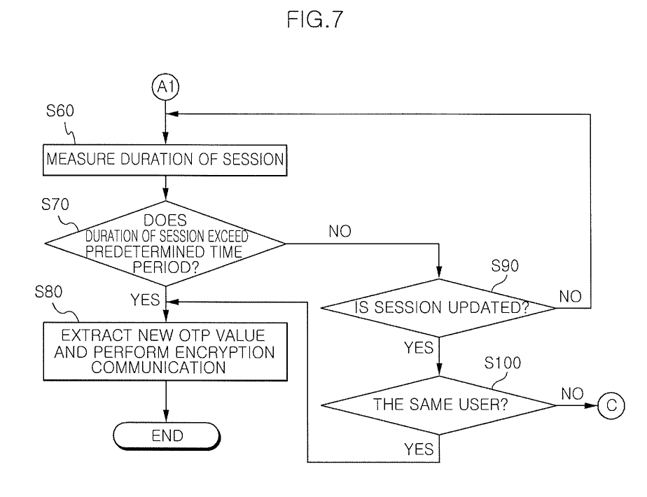

FIGS. 6 and 7 are flowcharts illustrating the communication method according to this embodiment. As shown in FIG. 6, the user computer 10 uses the OTP generator to generate an OTP value (S10). That is, the first encryption communication module 110 of the user computer 10 extracts the OTP value generated by the OTP generator 120.

Then, the user computer 10 transmits user information (ID and password) and the OTP value generated by the OTP generator to the service server 20 that the user computer 10 wants to access (S20).

The service server 20 performs a first user authentication process using the user information provided from the user computer 10 (S30).

Then, the service server 20 queries the OTP integrated authentication server for the received OTP value to perform a second user authentication (S40). That is, the service server 20 performs the user authentication of the user computer 10 using a variable OTP value as well as the user information. Therefore, it is possible to stably maintain the security of communication.

When the first and second user authentication processes between the user computer 10 and the service server 20 are completed, the service server 20 establishes a session for communication, and performs encryption communication using the authenticated OTP value (S50). That is, in order to perform encryption communication, the user computer 10 encodes a message using the OTP value generated by the OTP generator 120 as an encryption key, and transmits the encoded message to the service server 20. The service server 20 decodes the message received from the user computer 10 using the OTP value subjected to user authentication by the OTP integrated authentication server 30. In this way, encryption communication is performed. That is, in this embodiment, user authentication is performed using an OTP value, and communication using encoded data is performed using the secured OTP value. Therefore, it is possible to protect communication from hacking. Further, since the OTP generator is used to generate a key required for encryption, it is possible to simplify the generation of an encryption key.

Next, processes after Step S50 (reference numeral Al) will be described with reference to FIG. 7. The user computer 10 measures the duration of a session for data communication with the service server 20 (S60).

The user computer 10 determines whether the duration of the session to the service server 20 exceeds a predetermined time period (S70).

When it is determined in Step S70 that the duration of the session exceeds the predetermined time period, a new OTP value used for encryption communication between the user computer 10 and the service server 20 is extracted, and then used for the encryption communication (S80).

On the other hand, when it is determined in Step S70 that the duration of the session does not exceed the predetermined time period, the service server 20 determines whether to update the session to the user computer 10 (S90). When it is determined to update the session in Step S90, the service server 20 determines whether the same user computer 10 is used (S100). That is, as described above, it is possible to identify the same user using access information (for example, user information, an OTP value, and an IP address of the user computer) of the user computer.

When it is determined in Step S100 that the same user computer 20 accesses the service server 20, a new OTP value is extracted and used for encryption communication (S80).

When it is determined in Step S100 that the same user computer 20 does not access the service server 20, the user authentication process (Steps S10 to S50) is performed again (see reference character C).

In this way, in this embodiment, the OTP value used as the encryption key is frequently changed at a predetermined time interval, which makes it possible to perform encoded data communication. That is, according to this embodiment, even when the OTP value is disclosed to the outside, the OTP value is changed after a predetermined time has elapsed. Therefore, it is possible to improve security.

Further, when a session established between the user computer 10 and the service server 20 during communication is updated, a new OTP value can be generated regardless of the duration of the session and used as the encryption key. That is, according to this embodiment, even when the user computer moves or accesses the Internet in order to receive a new service, it is possible to perform encryption communication using a new OTP value. As a result, it is possible to improve security of communication.

Therefore, the communication system according to the embodiment of the invention can improve the security of communication over the Internet through user authentication and encryption communication using the OTP between the user computer 10 and the service server 20.

Further, the use of a variable OTP value makes it possible to simplify the structure of an encryption key generation management portion that requires a lot of processing operations and management systems during encryption communication according to the related art.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A user computer for using a communication service, comprising:
an OTP generator that generates a one time password (OTP); and
a first encryption communication module that transmits user information and an OTP value generated by the OTP generator to a service server which provides the communication service, in order to perform user authentication, and performs encryption communication with the service server using data encoded by the OTP value.

2. The user computer of claim 1,
wherein the first encryption communication module includes:
a first timer that measures the duration of a session established for the encryption communication, and
the first encryption communication module receives a new OTP value from the OTP generator at a predetermined time interval of the duration of the session that is measured by the first timer, and encodes communication data.

3. The user computer of claim 1,
wherein the first encryption communication module includes:
a session monitoring unit that monitors whether the session established for the encryption communication is updated, and
whenever the session monitoring unit determines that the session is updated, the first encryption communication module receives a new OTP value from the OTP generator and encodes communication data.

4. The user computer of claim 1,
wherein the first encryption communication module includes:
a first encoding/decoding unit that encodes or decodes communication data using the OTP value as an encryption key, and
the first encoding/decoding unit converts the size and/or value of the OTP and uses the converted data as the encryption key.

5. A service server for providing a communication service, comprising:
a second encryption communication module that performs a first user authentication process on the basis of user information input from a user computer that requests the communication service, verifies an OTP value input from the user computer through communication with an OTP integrated authentication server, thereby performing a second user authentication process, and when the user authentication of the user computer succeeds, performs encryption communication with the user computer using encoded data that is associated with the OTP value.

6. The service server of claim 5,
wherein the second encryption communication module includes:
a session establishing unit that establishes a session for encryption communication with the user computer, and
whenever the session establishing unit establishes the session in response to the communication service request of the user computer, the second encryption communication module receives a new OTP value from the OTP integrated authentication server, and encodes communication data.

7. The service server of claim 6,
wherein the second encryption communication module includes:
a second timer that measures the duration of the session established by the session establishing unit, and
the second encryption communication module receives a new OTP value from the OTP integrated authentication server at a predetermined time interval of the duration of the session that is measured by the second timer, and encodes communication data.

8. The service server of claim 5,
wherein the second encryption communication module includes:
a session establishing unit that establishes a session for encryption communication with the user computer, and
when initial user authentication of the user computer succeeds using user information and the OTP value that are input from the user computer and the session establishing unit establishes a new session in response to a communication service request of the user computer, the second encryption communication module skips the user authentication process.

9. The service server of claim 5,
wherein the second encryption communication module includes:
a second encoding/decoding unit that encodes or decodes communication data using the OTP value as an encryption key, and
the second encoding/decoding unit converts the size and/or value of the OTP and uses the converted data as the encryption key.

10. A communication method using a one time password (OTP), comprising:
receiving user information and an OTP value from a user computer in a service server;
performing a first user authentication process using the user information;
querying an OTP integrated authentication server for the OTP value to verify the OTP value, thereby performing a second user authentication process; and
when the first and second user authentication processes succeed, establishing a session for communication with the user computer, and performing encryption communication through the established session, using data encoded by the OTP value.

11. The communication method of claim 10,
wherein the performing of the encryption communication includes:
measuring the duration of the session established for the encryption communication; and
receiving a new OTP value from the OTP integrated authentication server at a predetermined time interval of the duration of the session, and encoding communication data.

12. The communication method of claim 10,
wherein the performing of the encryption communication includes:
determining whether the session established for the encryption communication is updated; and
whenever it is determined that the session is updated, receiving a new OTP value from the OTP integrated authentication server and encoding the communication data.

13. The communication method of claim 12,
wherein the performing of the encryption communication further includes:
whenever it is determined that the session is updated, determining whether the same user computer accesses.

14. A communication method using a one time password (OTP), comprising:
receiving an OTP value for user authentication from an OTP generator in a user computer;
transmitting user information and the OTP value to a service server; and
when the user authentication succeeds and the service server establishes a session for communication, performing encryption communication through the established session, using data encoded by the OTP value.

15. The communication method of claim 14,
wherein the performing of the encryption communication includes:
measuring the duration of the session established for the encryption communication; and
receiving a new OTP value from the OTP generator at a predetermined time interval of the duration of the session and encoding communication data.

16. The communication method of claim 14,
wherein the performing of the encryption communication includes:
determining whether the session established for the encryption communication is updated; and
whenever it is determined that the session is updated, receiving a new OTP value from the OTP generator and encoding the communication data.
